(19) United States
(12) Patent Application Publication
(10) Pub. No.: US 2003/0157885 A1
(43) Pub. Date: Aug. 21, 2003

(54) CATV amplifier bypass repeater for digital data and systems including same

(76) Inventors: Jeffrey Lukkarila, Knoxville, TN (US); Wayne Williamson, Talbott, TN (US); Robin B. Rumbolt, Knoxville, TN (US)

Correspondence Address: PHILIPS INTELLECTUAL PROPERTY & STANDARDS, P.O. BOX 3001, BRIARCLIFF MANOR, NY, 10510, US

(21) Appl. No.: 10/358,035

(22) Filed: Feb. 4, 2003

Related U.S. Application Data
(60) Provisional application No. 60/353,175, filed on Feb. 4, 2002.

(51) Int. Cl. H04B 3/36

(52) U.S. Cl. 455/11.1; 455/7

(57) ABSTRACT

A bypass data repeater (40) permitting data signals to bypass a CATV amplifier (30) in a CATV system (1) includes a downstream data path including a first data receiver (401) and a first data transmitter (402) serially coupled to one another, an upstream data path including a second data receiver (403) and a second data transmitter (404) serially coupled to one another, and circuitry (405, 406 or 412, 413) for temporarily disabling one of the first and second data transmitters (402, 403) when the data signals are received by a respective one of the second and first data receivers (403, 401). A CATV system (1) permitting data signals to pass bidirectionally between a headend (HE) and a television (TV) to bypass a CATV amplifier (30) is also described.

### RELATED APPLICATIONS

The present application also claims priority from Provisional Patent Application No. 60/353,175 of Feb. 4, 2002, which application is incorporated by reference in its entirety.

### BACKGROUND OF THE INVENTION

The present invention relates generally to institutional community antenna television (CATV) installations carrying both video programs and digital data. More specifically, the present invention relates to data repeaters for CATV installations carrying both video programs and digital data in separate frequency bands.

CATV systems typically route data signals, e.g., digital data signals, in opposite directions by putting upstream and downstream going signals, the direction being specified with respect to the CATV headend, on different frequencies. It will be appreciated that this requires that the CATV installation include multiple diplex filters and amplifiers in both the upstream and downstream signal paths. More specifically, convention CATV installations require a system of bandpass or diplex filters, i.e., three-port frequency-dependent devices employed as a separator or a combiner of signals, to allow the data signals at subband frequencies to be routed around the CATV signal amplifiers. See U.S. Pat. No. 5,81,362, which patent is incorporated herein by reference.

It will be appreciated that use of such diplex filters does not allow full amplification of the data signals since the data signals in such installations are amplified in both directions simultaneously, which would normally result in an undesirable feedback situation.

What is needed is a bypass repeater associated with the amplifiers in a CATV system. Moreover, what is needed is a bypass repeater operating at subband frequencies for routing digital data signals around the amplifiers in a CATV system. It would be beneficial if the bypass repeater were a half-duplex bypass repeater. Furthermore, a bypass repeater that could be implemented at low cost would be extremely desirable.

### SUMMARY OF THE INVENTION

Based on the above and foregoing, it can be appreciated that there presently exists a need in the art for a community antenna television (CATV) amplifier bypass repeater that overcomes the above-described deficiencies. The present invention was motivated by a desire to overcome the drawbacks and shortcomings of the presently available technology, and thereby fulfill this need in the art.

According to one aspect, the CATV amplifier bypass repeater according to the present invention permit digital data signals, which signals have frequencies outside of the bandpass of the CATV amplifiers, and which are applied to or generated by downstream televisions in the CATV system to pass, i.e., to be regenerated or repeated, in both directions.

In one aspect, the present invention provides a bypass data repeater permitting data signals to bypass a CATV amplifier in a CATV system, including downstream data path circuitry conducting the data signals in a downstream direction, upstream data path circuitry conducting the data signals in an upstream direction, and circuitry for temporarily disabling the downstream data path circuitry when the upstream data path circuitry is conducting the data signals, and vice versa. If desired, each of the upstream and downstream data path circuitry includes respective upstream and downstream data receivers. In a first exemplary embodiment, each of the upstream and downstream data receivers is responsive to a control signal indicative of data signals being conducted by the downstream and upstream data receivers, respectively. The control signal can include first and second control signals generated responsive to the output signals of the downstream and upstream data receivers, respectively. Furthermore, when the first and second control signals correspond to pulse stretched versions of the output signals of the downstream and upstream data receivers, respectively, each of the upstream and downstream data path circuitry further includes respective upstream and downstream data transmitters. In a second exemplary embodiment, each of the upstream and downstream data transmitters is responsive to a control signal indicative of data signals being conducted by the downstream and upstream data receivers, respectively. This control signal can also include first and second control signals generated responsive to conduction of the data signals via the downstream and upstream data receivers, respectively. Furthermore, each of the upstream and downstream data path circuitry further includes respective upstream and downstream delay circuits, which delay circuits generate the first and second controls signals, respectively.

In another aspect, the present invention provides a bypass data repeater permitting data signals to bypass a CATV amplifier in a CATV system, including a downstream data path including a first data receiver and a first data transmitter serial coupled to one another, an upstream data path including a second data receiver and a second data transmitter serial coupled to one another, and circuitry for temporarily disabling one of the first and second data transmitters when the data signals are received by a respective one of the second and first data receivers. If desired, each of the first and second data receivers is responsive to a control signal indicative of data signals being conducted by the and upstream and downstream data receivers, respectively. Moreover, the control signal can include first and second control signals generated responsive to the output signals of the upstream and downstream data receivers, respectively. When the first and second control signals correspond to pulse stretched versions of the output signals of the upstream and downstream data receivers, respectively, first and second pulse shaping circuits are associated with the bypass data repeater. Alternatively, each of the upstream and downstream data transmitters can be responsive to a control signal indicative of data signals being conducted by the downstream and upstream data receivers, respectively. Furthermore, when the control signal includes first and second control signals generated responsive to conduction of the data signals via the downstream and upstream data receivers, respectively, each of the upstream and downstream data paths can include respective upstream and downstream delay circuits, which delay circuits generate the first and second controls signals, respectively.

In a further aspect, the present invention provides a CATV system permitting data signals passing bidirectionally between a headend and a television to bypass a CATV amplifier, including an upstream signal splitter operatively connected to the headend, the CATV amplifier which operates above a predetermined frequency, and a bypass data repeater, which operates below the predetermined frequency, a downstream signal splitter operatively connected to the television, the CATV amplifier, and the bypass data repeater, and the bypass data repeater. If desired, the bypass data repeater includes a downstream data path including a first data receiver and a first data transmitter serial coupled to one another, an upstream data path including a second data receiver and a second data transmitter serial coupled to one another, and circuitry for temporarily disabling one of the first and second data transmitters when the data signals are received by a respective one of the second and first data receivers. When the television is replaced by multiple televisions, the downstream signal splitter can be replaced by a signal splitter network permitting the televisions to be operatively connected the headend via parallel paths. In any case, the CATV system can also include a high pass filter, having a pass band greater than of equal to the predetermined frequency, operatively connected between the upstream signal splitter and the CATV amplifier.

### BRIEF DESCRIPTION OF THE DRAWINGS

These and various other features and aspects of the present invention will be readily understood with reference to the following detailed description taken in conjunction with the accompanying drawings, in which like or similar numbers are used throughout, and in which:

FIG. 1 is a high-level block diagram of a CATV amplifier bypass repeater system according to the present invention;

FIG. 2 is a high-level block diagram of a single-input/multiple-output CATV amplifier bypass repeater system arrangement according to an alternative embodiment of the present invention;

FIG. 3 is a high-level block diagram of a first preferred embodiment of the bypass repeater according to the present invention, which can be employed the systems illustrated in FIGS. 1 and 2; and

FIG. 4 is a high-level block diagram of a second preferred embodiment of the bypass repeater according to the present invention, which can also be employed the systems illustrated in FIGS. 1 and 2.

### DETAILED DESCRIPTION OF THE PREFERRED EMBODIMENTS

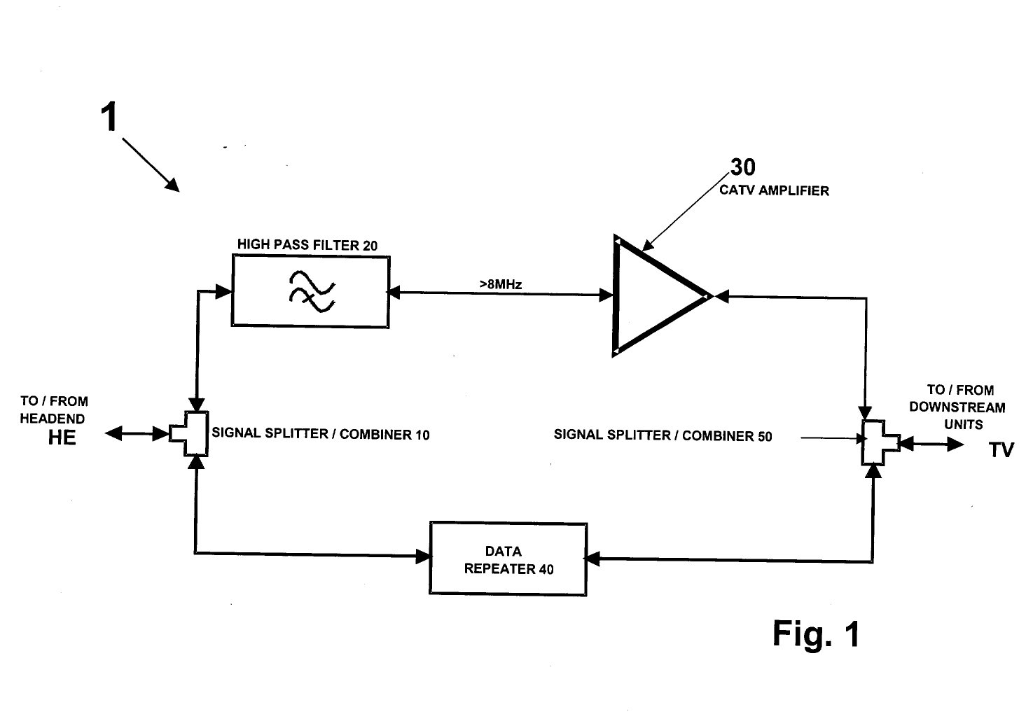

A CATV amplifier assembly 1 including the bypass repeater 40 according to the present invention will now be described with references to FIG. 1, which includes upstream and downstream signal splitters 10 and 50, respectively, forming a circuit with two parallel branches connecting a headend HE to a television TV. Advantageously, the signal splitters 10 and 50 can be conventional splitter/combiner elements well known to one of ordinary skill in the art. One branch of the CATV amplifier assembly 1 includes a high pass filter 20 and a CATV amplifier 30; the other branch contains the bandpass repeater 40.

It should be noted that the high pass filter 20 preferably provides an 8 MHz cutoff adapted to pass the video signal to the CATV amplifier 30. It should also be noted that the attenuation of the high pass filter 20 is sufficiently high as to prevent passage of the 7.5 MHz bypass data signal via the CATV amplifier 30. Multiple high pass filters disposed in series advantageously can be employed as the filter 20. It will be appreciated that when the 7.5 MHz is not blocked, a feedback situation will occur, rendering the repeater inoperative and generating considerable TV interference.

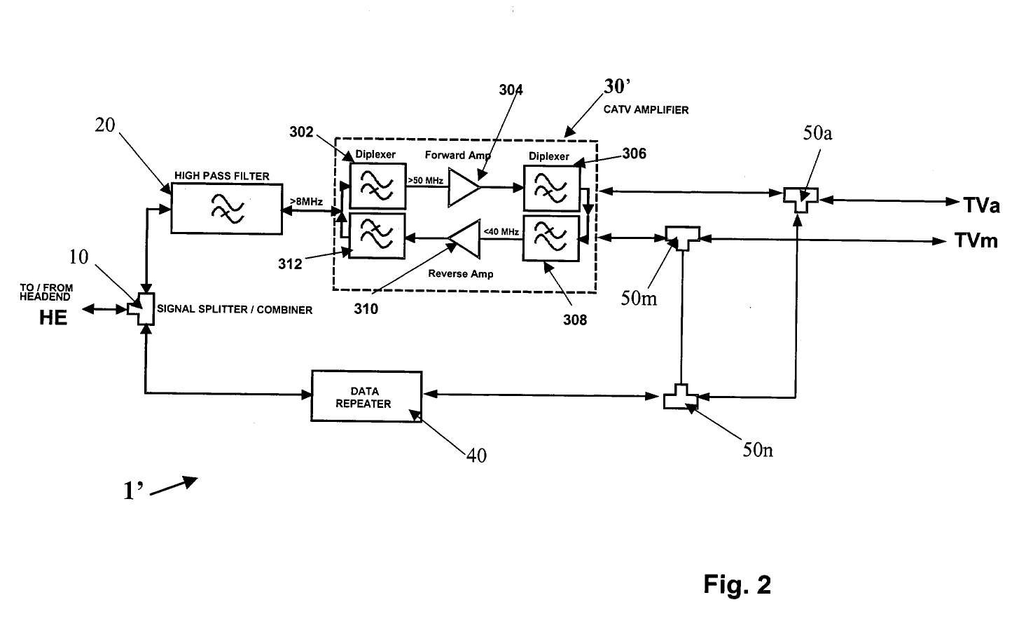

FIG. 2 is a high-level block diagram of a CATV amplifier assembly 1′, which advantageously includes a single input/multiple output CATV amplifier 30′ connecting a single headend HE to multiple televisions TVa, . . . , TVm. It should also be noted that the CATV amplifier 30′ includes, in an exemplary case, a downstream branch including diplexers 302 and 306, which are coupled to one another by an amplifier 304. Similarly, an upstream branch in the amplifier 30′ includes a pair of diplexers 308 and 312 electrically coupled to one another via an amplifier 310. It should be mentioned that the upstream branch in the exemplary CATV amplifier 30′ operates at a nominal 50 MHz while the downstream branch operates at a nominal 40 MHz. The arrangement of elements in CATV amplifier 30′ is often encountered by seldom employed. Stated another way, the reverse amplifier 310 could cause problems if its output is not attenuated enough with respect to the repeater output. As mentioned above, it is extremely important that no 7.5 MHz signal be allowed to pass through the CATV line amplifier 30′ in either direction! If 7.5 MHz is not blocked, a feedback situation will occur, rendering the repeater inoperative and generating unacceptable TV interference. It will be noted that dual amps are common and could technically be used if reverse amp 310 is disabled, which is usually accomplished by removing filter modules on input stage.

It will be appreciated that in order to accommodate digital data disposed in another frequency band, it would normally be necessary to repeat the arrangement of diplexers and amplifiers, as discussed above. However, the bypass repeated 40, discussed in greater detail below, eliminates the need for additional diplexers and the cost associated therewith.

It will be appreciated that the each output feed from the amplifier 30′ includes one of the signal splitters 50a-50m disposed upstream of the televisions TVa-TVm. A return path for the bypass data signals from any of all of televisions TVa-TVm to the bandpass repeater 40 is provided via signal splitters 50a-50n. In the illustrated exemplary embodiment, n and m are integers; preferably, n=m+1.

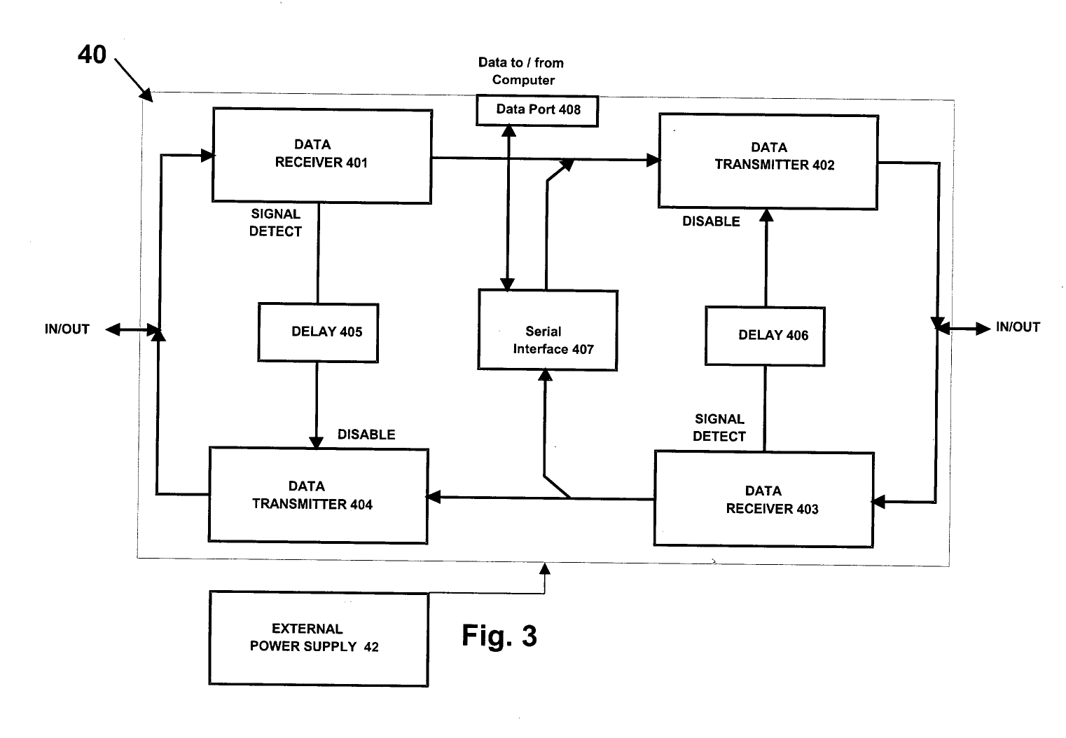

FIG. 3 is a high-level block diagram of a bypass data repeater 40, which advantageously can be employed in either of the CATV systems illustrated in FIGS. 1 and 2. More specifically, the bypass data repeater 40 includes a forward data receiver 401 and a forward data transmitter 402 in one branch, i.e., transmission path, and a backward data receiver 403 and a backward data transmitter 404 in another, parallel branch. Each of the receivers 401, 403 generates a detect signal when digital data is present on the respective branch. The detect signal from the receiver 401 is applied to a delay circuit 405, which advantageously can be a resistor-capacitor (RC) circuit providing a long time delay constant. Other forms of delay circuit will readily occur to one of ordinary skill in the art and all such delay circuits are considered to be within the scope of the present invention. In any event, the output of the delay circuit is a disable signal, which advantageously can be provided to the backward data transmitter 404. Thus, when digital data is being transmitted to downstream components, i.e., television sets (not shown) connected to, for example, the CATV system 1′, the return data path of the bypass data repeater 40 is temporally disabled. The transmitter 402 advantageously can be disabled in a similar manner when digital data is present in the backward branch of the bypass data repeater 40, i.e., when a signal is detected by data receiver 403.

Still referring to FIG. 3, it will be noted that the bypass data repeater 40 advantageously includes a serial interface device 407, which permits data to be introduced into either the forward branch, i.e., upstream of data transmitter 402, or the backwards branch, i.e., upstream of the data transmitter 404, through the bypass data repeater from a computer (not shown) via a data port 408.

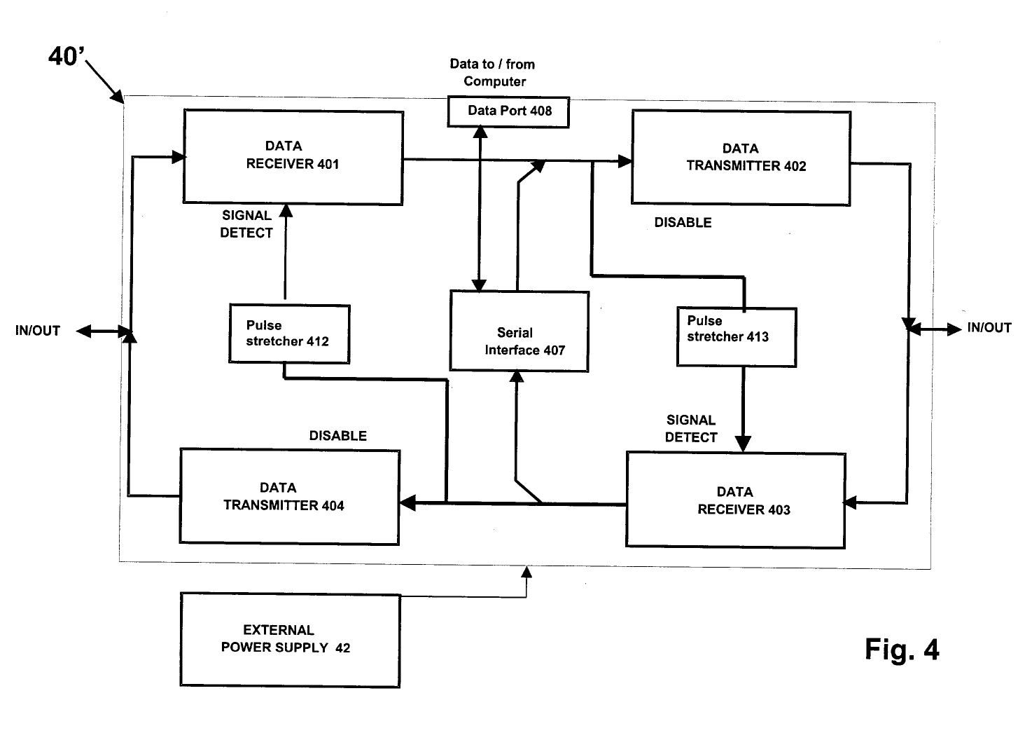

FIG. 4 is a high-level block diagram of a bypass data repeater 40′, which advantageously can also be employed in the CATV systems illustrated in FIGS. 1 and 2. More specifically, the bypass data repeater 40′ includes a forward data receiver 401 and a forward data transmitter 402 in one branch, i.e., transmission path, and a backward data receiver 403 and a backward data transmitter 404 in another, parallel branch. The output signals form the receivers 401, 403 advantageously can be applied to pulse stretcher circuits 412 and 413, which circuits can be the above mentioned resistor-capacitor (RC) circuits providing a long time delay constant. Other forms of pulse stretching circuit, such as those employed in connection with PWM controls, will readily occur to one of ordinary skill in the art and all such pulse stretcher circuits are considered to be within the scope of the present invention. In any event, the output of the pulse stretcher circuits is a disable signal, which advantageously can be provided to a respective one of the forward receiver 401 or the backward data receiver 403. Thus, when digital data is being transmitted ether to upstream or downstream components, i.e., television sets (not shown), the opposite branch of the bypass data repeater 40′ is temporally disabled.

It should be mentioned that either of the bypass data repeaters 40, 40′ advantageously permits 7.5 MHz data to bidirectionally bypass the CATV line amplifiers, which, for the reasons mentioned above, must not pass 7.5 MHz in either or both directions. Preferably, each of the bypass data repeaters 40, 40′ is composed of back-to-back transmitter/receiver pairs. In an exemplary case, the data signal is completely demodulated, then re-modulated, and retransmitted at full transmitter output level. It will be appreciated that the bypass data repeater is a half-duplex device.

As illustrated in, for example, FIG. 1, the bypass data repeater according to the present invention is connected, via signal splitters 10 and 50, in parallel with the CATV line amplifier 30, which is a typical CATV band split amp. It will be appreciated that an 8 MHz high pass filter 20 is disposed in line with the amplifier to prevent the introduction of the 7.5 MHz data signal into the amplifier 30. Again, it is very important that no portion of the 7.5 MHz data signal be allowed to pass through the CATV line amplifier 30 in either direction. If 7.5 MHz is not blocked, undesirable feedback will occur, which feedback could render the repeater inoperative, generate considerable TV interference, or both.

It should be mentioned that the input/output (I/O) ports of the bypass data repeaters 40, 40′ are AC coupled devices, allowing these repeaters to be employed with amplifiers powered via coax cable. It will be appreciated that appropriate current passing splitters and high pass filters must be used in connections as shown above.

As illustrated in FIGS. 3 and 4, the bypass data repeater 40, 40′ advantageously can be powered from 12 VDC supplied by an external power adapter 42 that requires 120 VAC. However, the bypass data repeater may be powered from any external 12 VDC source capable of supplying the nominal 100 milliamperes of current employed by the exemplary bypass data repeaters 40, 40′.

Although presently preferred embodiments of the present invention have been described in detail herein, it should be clearly understood that many variations and/or modifications of the basic inventive concepts herein taught, which may appear to those skilled in the pertinent art, will still fall within the spirit and scope of the present invention, as defined in the appended claims.

What is claimed is:

1. A bypass data repeater (40) permitting data signals to bypass a CATV amplifier (30) in a CATV system (1), comprising:
downstream data path circuitry (401, 402) conducting the data signals in a downstream direction;
upstream data path circuitry (403, 404) conducting the data signals in an upstream direction; and
circuitry (405, 405 or 412, 413) for temporarily disabling the downstream data path circuitry when the upstream data path circuitry is conducting the data signals, and vice versa.

2. The bypass data repeater as recited in claim 1, wherein each of the upstream and downstream data path circuitry includes respective upstream and downstream data receivers (403, 401).

3. The bypass data repeater as recited in claim 2, wherein each of the upstream and downstream data receivers (403, 401) is responsive to a control signal indicative of data signals being conducted by the downstream and upstream data receivers, respectively.

4. The bypass data repeater as recited in claim 3, wherein the control signal comprises first and second control signals generated responsive to the output signals of the downstream and upstream data receivers, respectively.

5. The bypass data repeater as recited in claim 4, wherein the first and second control signals correspond to pulse stretched versions of the output signals of the downstream and upstream data receivers (403, 401), respectively.

6. The bypass data repeater as recited in claim 2, wherein each of the upstream and downstream data path circuitry further comprises respective upstream and downstream data transmitters (404, 402).

7. The bypass data repeater as recited in claim 6, wherein each of the upstream and downstream data transmitters (404, 402) is responsive to a control signal indicative of data signals being conducted by the downstream and upstream data receivers (401, 403), respectively.

8. The bypass data repeater as recited in claim 7, wherein the control signal comprises first and second control signals generated responsive to conduction of the data signals via the downstream and upstream data receivers (401, 403), respectively.

9. The bypass data repeater as recited in claim 8, wherein each of the upstream and downstream data path circuitry further comprises respective upstream and downstream delay circuits (406, 405), which delay circuits generate the first and second controls signals, respectively.

10. A bypass data repeater (40, 40′) permitting data signals to bypass a CATV amplifier (30, 30′) in a CATV system (1, 1′), comprising:
a downstream data path including a first data receiver (401) and a first data transmitter (402) serially coupled to one another;
an upstream data path including a second data receiver (403) and a second data transmitter (404) serially coupled to one another; and
circuitry (405, 406 or 412, 413) for temporarily disabling one of the first and second data transmitters when the data signals are received by a respective one of the second and first data receivers.

11. The bypass data repeater as recited in claim 10, wherein each of the first and second data receivers is responsive to a control signal indicative of data signals being conducted by the and upstream and downstream data receivers, respectively.

12. The bypass data repeater as recited in claim 10, wherein the control signal comprises first and second control signals generated responsive to the output signals of the upstream and downstream data receivers, respectively.

13. The bypass data repeater as recited in claim 12, wherein the first and second control signals correspond to pulse stretched versions of the output signals of the upstream and downstream data receivers, respectively.

14. The bypass data repeater as recited in claim 10, wherein each of the upstream and downstream data transmitters is responsive to a control signal indicative of data signals being conducted by the downstream and upstream data receivers, respectively.

15. The bypass data repeater as recited in claim 14, wherein:
the control signal comprises first and second control signals generated responsive to conduction of the data signals via the downstream and upstream data receivers, respectively; and
each of the upstream and downstream data paths further comprises respective upstream and downstream delay circuits (406, 405), which delay circuits generate the first and second controls signals, respectively.

16. A CATV system (1, 1′) permitting data signals passing bidirectionally between a headend (HE) and a television (TV) to bypass a CATV amplifier (30, 30′), comprising:
an upstream signal splitter (10) operatively connected to the headend (HE), the CATV amplifier (30, 30′), which operates above a predetermined frequency, and a bypass data repeater (40, 40′), which operates below the predetermined frequency;
a downstream signal splitter (50) operatively connected to the television (TV), the CATV amplifier (30, 30′), and the bypass data repeater (40, 40′); and
the bypass data repeater (40, 40′), which includes:
a downstream data path including a first data receiver (401) and a first data transmitter (402) serially coupled to one another;
an upstream data path including a second data receiver (403) and a second data transmitter (404) serially coupled to one another; and
circuitry (405, 406 or 412, 413) for temporarily disabling one of the first and second data transmitters when the data signals are received by a respective one of the second and first data receivers.

17. The CATV system as recited in claim 16, wherein:
each of the first and second data receivers is responsive to first and second control signal indicative of data signals being conducted by the upstream and downstream data receivers, respectively, the first and second control signals corresponding to pulse stretched versions of the output signals of the upstream and downstream data receivers, respectively; and
each of the upstream and downstream data paths further comprises respective upstream and downstream pulse shaping circuits (413, 412), which pulse shaping circuits generate the first and second controls signals, respectively.

18. The CATV system as recited in claim 16, wherein:
each of the upstream and downstream data transmitters is responsive to first and second control signals indicative of data signals being conducted by the downstream and upstream data receivers, respectively, the first and second control signals being generated responsive to conduction of the data signals via the downstream and upstream data receivers, respectively; and
each of the upstream and downstream data paths further comprises respective upstream and downstream delay circuits (406, 405), which delay circuits generate the first and second controls signals, respectively.

19. The CATV system as recited in claim 16, wherein:
the television (TV) further comprises a plurality of televisions (TVa-TVm); and
the downstream signal splitter (50) further comprises a signal splitter network (50a-50n) permitting the televisions (TVa-TVm) to be operatively connected the headend (HE) via parallel paths.

20. The CATV system as recited in claim 16, further comprising a high pass filter (20), having a pass band greater than of equal to the predetermined frequency, operatively connected between the upstream signal splitter (10) and the CATV amplifier (30, 30′).
